(19) United States
(12) Patent Application Publication
(10) Pub. No.: US 2023/0177472 A1
(43) Pub. Date: Jun. 8, 2023

(54) METHOD FOR DETECTING INACCURACIES AND GAPS AND FOR SUGGESTING DETERIORATION MECHANISMS AND ACTIONS IN INSPECTION REPORTS

(71) Applicants: Petróleo Brasileiro S.A. - Petrobras, Rio de Janeiro (BR); Faculdades Catolicas, Rio de Janeiro (BR)

(72) Inventors: Andre Seichi Ribeiro Kuramoto, São José dos Campos (BR); Silvio Alonso Marques, Rio de Janeiro (BR); Hervandil Morosini Sant´Anna, Rio de Janeiro (BR); Antonioni Barros Campos, Rio de Janeiro (BR); Rafael Adriano Guimaraes Dos Reis, Betim (BR); Jose Ademar Nucci Etter, Paulínia (BR); Paulo Roberto Moraes, Canoas (BR); Adriano Tadeu Armond Marques, Rio de Janeiro (BR); Sidney Comandulli, Araucária (BR); Marcos Kalinowski, Rio de Janeiro (BR); Jacques Chueke, Rio de Janeiro (BR); André Luiz De Brandão Damasceno, Rio de Janeiro (BR); Bianca Rodrigues Teixeira, Rio de Janeiro (BR); Gustavo Henrique Dian, São José dos Campos (BR)

(21) Appl. No.: 18/061,068

(22) Filed: Dec. 2, 2022

(30) Foreign Application Priority Data
Dec. 3, 2021 (BR) 10 2021 024549 2

(51) Int. Cl. G06Q 10/20

(52) U.S. Cl. CPC G06Q 10/20

(57) ABSTRACT

The present invention reveals, through the use of artificial intelligence techniques and natural language processing, a method that detects inaccuracies and gaps in the wording of inspection reports, providing online alerts to inspectors. The method also provides recommendations regarding the filing of the report.

The method of this invention allows the inspection report, one of the stages of the inspection process, to be performed with greater efficiency, which is essential for the integrity of the equipment and for operational continuity.

### FIELD OF INVENTION

The present invention is related to the equipment inspection area, aiming to improve the quality of inspection reports.

### DESCRIPTION OF THE STATE OF THE ART

The integrity of equipment in industrial facilities, such as refineries, is ensured by a set of standardized management processes, in which the equipment analyzes are carried out by inspection specialists and documented in inspection reports. As with any other written text, eventually inspection reports may contain inaccurate wording or gaps relating to important information for the management process. It is essential that such inaccuracies in the wordings are identified and adjusted quickly so that the inspection process is carried out effectively, ensuring the accuracy and traceability of the information, essential characteristics for maintaining the SPIE (Serviço Próprio de Inspeção de Equipamentos—“Own Equipment Inspection Service”) certification, which ensures the extension of the legal deadlines for equipment maintenance.

The identification of inaccurate wording or gaps related to information important to the equipment inspection management process are detected through the samples analysis of the inspection reports set produced. If improvement needs are identified, the inspection management process is improved to enhance the wording of inspection reports. In short, there is no verification of 100% of the inspection report wordings.

Document WO2020133960A 1 discloses a text quality inspection method, electronic device, computer equipment, and storage medium, which has semantic comprehension capability, improving the quality inspection accuracy rate, alleviating the pressure on quality inspection personnel, and greatly improving the text quality inspection efficiency.

Document CN 111881292A discloses a text classification method and device that can determine precise and comprehensive target characteristics of the text to be classified according to the importance of multilevel text information included in the text to be classified, and determine text to be classified according to its target characteristics.

Document CN111242083A discloses a text processing method, apparatus, device, and medium based on artificial intelligence.

The documents obtained from the State of the Art reveal methods capable of recognizing entities in texts by means of artificial intelligence algorithms. However, the prior arts presented do not have the ability to identify inaccurate wording or gaps related to important information in inspection reports.

### OBJECT OF THE INVENTION

It is an object of the invention to suggest deterioration mechanisms and inspection recommendations, detect inaccuracies or gaps in the wording of inspection reports, providing online alerts to inspectors.

It is a further object of the invention to provide recommendations relating to the filing of an inspection report.

### BRIEF DESCRIPTION OF THE INVENTION

The present invention reveals, through the use of artificial intelligence techniques and natural language processing, a method that detects inaccuracies or gaps in the wording of inspection reports, providing online alerts to inspectors.

### BRIEF DESCRIPTION OF DRAWINGS

The present invention will be described in more detail below, with reference to the attached figures which, in a schematic way and not limited of the inventive scope, represents an example of its realization.

FIG. 1 illustrates a flowchart of the method for detecting inaccuracies and gaps in inspection report wording, according to this invention. The flowchart shows: Inspection professionals (A), User interface (8), Cause and damage detection algorithms and inference of recommended action and deterioration mechanism (C), Training database (D), Supervised training algorithms of the deterioration mechanism and recommended actions inference models (E), Text written by the user (1), Indication of inconsistencies and gaps and proposition of corrections (2), Inspection report analyzed or corrected by the inspection professional (3), Data for supervised training (4), Inference models (5).

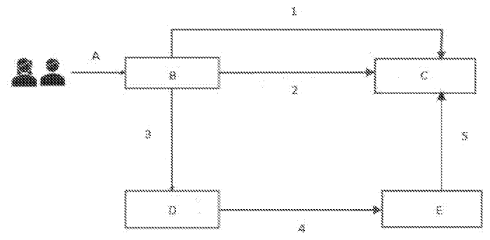

### DETAILED DESCRIPTION OF THE INVENTION

Below follows a detailed description of a preferred embodiment of the present invention, by way of example and in no way limiting. Nevertheless, it will be clear to a person skilled in the art, from the reading of this description, possible additional embodiments of the present invention further comprised by the essential and optional features below.

It is essential that inaccuracies in the wording of inspection reports are identified and quickly adjusted so that the inspection process can be carried out effectively, ensuring the accuracy and traceability of the information. These are essential characteristics for maintaining the SPIE (Serviço Próprio de Inspeção de Equipamentos—“Own Equipment Inspection Service”) certification, which ensures the extension of the legal deadlines for the equipment maintenance. Equipment stops for inspections within the maximum legal deadlines represent greater continuity of operations and productivity.

Using artificial intelligence (AI) techniques and natural language processing, the method of the invention detects inaccuracies or gaps in the wording of the inspection reports, providing online alerts to inspectors. Recommendations regarding the filing of the report are also given. The texts written in the inspection reports must have elements of:

### 1) Damage;

### 2) Cause;

3) Deterioration mechanism according to API 571 standard, and
4) Recommendation of action to be taken to ensure the integrity of the equipment.

These 4 elements must be present in the wording of the inspection report. Additionally, there are unfeasible combinations of these elements. For example, a type of damage that is not explained by some causes or some deterioration mechanisms. The method provided herein in this invention allows checking the text written during its edition, consulting the AI module integrated into the inspection report elaboration module. Verification includes text completeness (check if all 4 elements are present) and the consistency; for example, the existence of a type of damage that is not explained by some causes or some mechanisms of deterioration. Infeasible combinations are also known by the invention method, which, when detected, warns the inspection professional that there are inconsistencies in the report and recommends changes in elements 1, 2, 3 or 4, making consistent the report. If the report is not complete or consistent, the method of the invention allows the inspection professional to be notified, in addition to suggesting an insertion or editing of one or more (within the 4) elements of the text to make it complete and consistent. Thus, the invention helps the inspection professional to write inspection reports that do not give rise to doubts of interpretation.

The verification steps and suggestions made by the AI implemented in this invention are described below:

a) The AI recognizes in the text the entities that represent damage and cause. If one of them or both are not present, the user is informed that there is no report of cause, damage or both.
b) If there are two elements (damage and cause), they are tested for consistency, that is, it is checked whether a certain damage (consequence) is not compatible with its cause (for example, a “crushing” damage is not compatible with a cause of “corrosion”. If they are inconsistent, the inconsistency and suggested edits are presented to the user to make the combination of damage and cause consistent. If they are consistent, through an intent detector algorithm, one or more deterioration mechanisms are estimated based on the complete report that contains the consistent pair of damage and cause. The intent detector, also called intent recognizer or intent classifier, is an algorithm capable of classifying a text into predefined labels that represent with greater confidence what the text means. To offer this capability, the intent detector has a machine learning model, that is, a model based on data (texts), which has undergone supervised training with a training dataset comprising examples of texts and their labels. true. In this invention, there are two models. The first one was trained with a training dataset provided with thousands of inspection reports containing consistent damage and cause pairs and pre-defined labels of deterioration mechanism annotated by equipment inspection specialists. The second model will be described below. With the first model, the intent detector algorithm is able to process and classify online the full text of new inspection reports written by inspectors. The text is classified according to the predefined most likely deterioration mechanisms according to API 571 standard. Thus, the most likely deterioration mechanisms and compatible with the new inspection report are estimated.
c) If none of the estimated deterioration mechanisms are in the text, suggestions for editing the text with the estimated deterioration mechanisms are presented. If at least one of the estimated deterioration mechanisms is in the text, through a second machine learning model, the recommended action is estimated from the text that contains the consistent damage, cause and deterioration mechanism triad. This second machine learning model underwent supervised training with a training dataset provided with thousands of inspection reports containing the consistent damage, cause and deterioration mechanism triad and pre-defined labels of recommended actions annotated by inspection experts. equipment. With the second model, new text is sorted online into the most likely predefined recommended actions.
d) Analogously to the treatment of the deterioration mechanism element, if none of the estimated recommended actions are in the text, suggestions for editing the text with the estimated recommended actions are presented. If at least one of the recommended actions is in the text, the analysis thereof is concluded.

The method of the present invention was implemented in a cloud computing resource and provides an application programming interface (API) of representational state transfer (REST) type. In this computational resource, the text processing artificial intelligence (AI) algorithm (natural language processing, NLP) is executed, provided with the capabilities of word segmentation (tokenization), morphological analysis, sentiment analysis, entity extraction and intent detection machine learning models in trained texts for the specific cases of equipment inspection cited above.

The solution for this invention was integrated into the GINSPEQ (Sistema de Gestão da Inspeção de Equipamentos—“Equipment Inspection Management System”), used by Petrobras Refining to support the equipment inspection professional to control the structural integrity of the equipment and manage inspections, inputs to maintain safety of people and facilities, as well as providing data required by the IBP.

Integrated into the GINSPEQ, the method of the invention makes it possible to verify all physical condition reports and, in cases where the given suggestions are used in full, this knowledge is used directly to improve the AI. If any editing is performed, the AI is fed after the completion of the inspection flow and verification of the examples by human professionals. Therefore, the method implemented in the present invention has the ability to learn from good examples from the preparation of inspection reports, which has great long-term value (feedback, a fundamental characteristic for an AI algorithm).

The text written by the inspection professional in the field of the GINSPEQ system is sent for processing according to the method described herein through an “https” request to the REST API interface mentioned above. This interface responds with the completeness information, inconsistencies and suggestions for changing the text, as previously described.

If the suggestions sent by the method of the invention are used in full or edited by the inspection professional, they are saved in the training databases of the machine learning models. Periodically the machine learning models of the invention are retrained with this complementary data.

1- METHOD FOR DETECTING INACCURACIES AND GAPS IN WORDING INSPECTION REPORTS, characterized by comprising the following steps:
a) Recognizing in the original text the entities representing damage and cause;
b) Testing the entities, damage and cause, from step a) for consistency;
c) Estimating one or more deterioration mechanisms for the damage and cause pair;
d) In the absence of estimated deterioration mechanisms in the original text, suggesting edition thereof with the estimated deterioration mechanisms;
e) Estimating the recommended action for the damage, cause and deterioration mechanism triad;
f) In the absence of estimated recommended actions in the original text, presenting suggestions for editing the text with estimated recommended actions;
g) If at least one of the recommended actions is in the original text during step d), completing the text analysis;
h) If the suggestions of deterioration mechanism and recommended actions presented by the method of the invention are used in full or edited by the inspection professional, these are saved in the training databases of the machine learning models; periodically the machine learning models of the invention are retrained with this complementary data.

2- METHOD FOR DETECTING INACCURACIES AND GAPS IN WORDING INSPECTION REPORTS, according to claim 1, characterized in that in step a) the user is informed about the lack of reporting the cause, damage or both, when at least one or both entities representing damage and cause are absent.

3- METHOD FOR DETECTING INACCURACIES AND GAPS IN WORDING INSPECTION REPORTS, according to claim 1, characterized in that in step b), when the damage and cause pair is inconsistent, it presents to the user the inconsistency and the editing suggestions, making the combination of damage and cause consistent.

4- METHOD FOR DETECTING INACCURACIES AND GAPS IN WORDING INSPECTION REPORTS, according to claim 1, characterized in that in step b), when the damage and cause pair is consistent, it estimates one or more deterioration mechanisms for the damage and cause pair through an intent detector algorithm.

5- METHOD FOR DETECTING INACCURACIES AND GAPS IN WORDING INSPECTION REPORTS, according to claim 1, characterized in that in step c), when at least one of the estimated deterioration mechanisms is in the original text, it estimates the recommended action for the damage, cause and deterioration mechanism triad through a second intent detector algorithm.

6- METHOD FOR DETECTING INACCURACIES AND GAPS IN WORDING INSPECTION REPORTS, according to claim 1, characterized in that in step h), when the suggestions for the deterioration mechanism and recommended actions presented by the method of the invention are used in full or edited by the inspection professional, these are saved in the training databases of machine learning models; periodically the machine learning models of the invention are retrained with this complementary data.

7- METHOD FOR DETECTING INACCURACIES AND GAPS IN WORDING INSPECTION REPORTS, according to claim 1, characterized by comprising computational resources in the cloud and application programming interface (API) of the representational state transfer (REST) type; The artificial intelligence (AI) algorithm of text processing (NLP) is executed in the computational resource, provided with the capabilities of word segmentation (tokenization), morphological analysis, sentiment analysis, entity extraction and machine learning models of detection intent in trained texts for the specific cases of equipment inspection mentioned above.
